(19) United States
(12) Patent Application Publication
(10) Pub. No.: US 2004/0248471 A1
(43) Pub. Date: Dec. 9, 2004

(54) Method and apparatus for fastening cords

(75) Inventor: Daryl Beesley, South Lyon, MI (US)

Correspondence Address: BAKER & HOSTETLER LLP, Washington Square, Suite 1100, 1050 Connecticut Avenue, N.W., Washington, DC, 20036, US

(73) Assignee: United Dominion Industries, Inc.

(21) Appl. No.: 10/456,589

(22) Filed: Jun. 9, 2003

(51) Int. Cl. H01R 25/00

(52) U.S. Cl. 439/638

(57) ABSTRACT

A method and apparatus includes a cord having mating structures at either or both of the female and male adapter ends. The mating structures allow the cord to be lengthened and or attached to a piece of equipment.

### FIELD OF THE INVENTION

The present invention relates generally to attaching or extending the length of cords. More particularly, the present invention relates to attaching and connecting cords with a series of universal mating devices.

### BACKGROUND OF THE INVENTION

In many instances, there is a need to lengthen or extend a cord or line. The cord can be a power, data, telephone or instrument cord. In the example of power cords, the initial length might be sufficient but after relocating equipment within a structure, the length of the cord is insufficient for it to reach the power supply.

Previous solutions to the problem can be solved in a variety of ways. The power supply location could actually be relocated nearer to the equipment. This would require a electrician to come into the structure and either relocate the previous power supply junction or add a new one to the structure.

Many companies alter or change the location of equipment a number of times Ideally, it would be convenient to have the equipment located near an outlet each and every time. However, in reality, this is not always possible. To have an electrician come in each time requires resources that could often be used in more appropriate areas.

Alternatives to this problem have been to use extension cords. The extension cords are run from the power source to the piece of equipment. It is more economically feasible to run extensions for the cord from one location to another. One problem that does occur is that the cord is run in locations that make it more likely that it will be pulled from either the piece of equipment or cord. Either individuals, bicycles, cars, trucks or other devices in the path of the cord can become entangled with the device. At some point, the cord can become dislodged. The result is the piece of equipment becomes inoperable. The user of the equipment must then stop working and reconnect the dislodged cord.

Solutions to these problem have been numerous. One low-tech solution is to cover the extension cables with rug or some other type of structure. This allows traffic to pass over the area and in essence to prevent the cord from being pulled. An individual is less likely to get caught up in the cord as opposed to it being uncovered. However, this solution is rarely effective. The rug begins to move along with the cord.

Other solutions to this problem have been to place a conduit on top of the floor such that the extension is covered by the conduit in the area of traffic. One downside to the conduit is that the conduit has a tendency to move as traffic move over the conduit. Once the conduit begins to move, it has the tendency pull the cord out from either the piece of the equipment or the supply.

Additional solutions have been to secure the items with a fastener. This solution is more prevalent on the data cords than electrical supply cords. For example, the serial data ports on a standard IBM PC compatible port contains 25 pins. A serial cord with a female end is run from the serial port to a peripheral device such as a printer. To lengthen the cord, an extension cord is placed such that the ends are held together with a fastener. The fastener is secured to the device with the appropriate tool. Other possible fasteners are hooks and slots that are pushed into place by the technician.

Common problems with these type of extension devices is that it requires the technician to have a tool in hand when linking the cords. In some instances, the fastener is so small that it requires a specialized tool. The technician is not always equipped with such a tool.

Another problem is that not all adapters extending from the equipment contain the fastening holes for the fasteners. In this case, the technician is able to use the extension cord without the ability to secure the cords and prevent them from becoming detached.

Another dilemma with cords, in general, is the inability to attach them at a source or at the piece of equipment. For example, a computer contains a power unit to which a male receptacle is usually protruding from the rear of the device. The female end of a power cord is attached to the male receptacle of the power supply and the male end of the cord attached to the electrical power supply in the building. In critical data centers, it is important for these computers to be operating 24 hours a day, seven days a week. Many times technicians working in the computer center pull the cord by accident and as a result shut down a whole computer system. The affect is the loss of valuable computing time.

One solution to the problem has been to secure the cord with a fastener that is located on the male adapter itself or the through a slot attached to the adapter or cord. In either instance, it requires the use or tools or a specialized device.

Another solution that has been implemented in extending cords is to use an extender. An extender is another piece of equipment that is placed and attached at one end of the cord, while a new cord is placed at the other end of the extender. This is more prevalent when the cord has dual male adapter at both ends, such as in a copper cable connection. The extender is essentially a dual female adapter that enables the male connectors to be connected.

Accordingly, it is desirable to provide a method and apparatus that allows a technician to extend and secure a cable or cord efficiently and effectively. It is desirable to provide an apparatus that allows the technician to connect and secure an extension cable without the need for tools or any other specialized device. It is also desirable to provide a system that allows the cords to be secured to either a source outlet or a piece of equipment. Additionally, it is desirable to provide an apparatus that is able connect to either or both a cord or another object such as a receptacle or piece of equipment without the need for extra equipment.

### SUMMARY OF THE INVENTION

The foregoing needs are met, to a great extent, by the present invention, wherein in one aspect an apparatus provides a mating device at either or both ends of the line or cord. The mating devices ensure that the cord is linked to a piece of equipment, another cord or a supply outlet. By attaching the cords with the mating device, the present invention ensures that the connection stays attached even under unusual circumstances.

In accordance with one embodiment of the present invention, an apparatus for connecting cords includes a cord comprising a first end and a second end, a first adapter attached to the first end of the cord and a first mating device configured to be placed over the adapter. The apparatus can further include a second adapter attached to the second end of the cord and a second mating configured to be placed over the second adapter.

In the preferred embodiment, the first adapter is a male adapter and the second adapter is a female adapter. The first mating and second mating are capable of being retractable over the adapters and the cord.

In attaching the cord to other cords, the first mating is attached to a third mating of a second cord and the second mating is attached to a fourth mating of the second cord. In this example, the second cord extends the length cord. In an alternate embodiment, the cord attached to a piece of equipment. The type of cord which can be used with the mating devices are data, power or telephone cords.

In the preferred embodiment, the first mating includes a housing having a primary and secondary end. The housing is configured to be large enough to be placed around the first adapter. The primary end has an opening for the cord and the secondary end has an opening for the first adapter. External threads extend from the secondary opening or the threads can be internal to the mating device.

In accordance with another embodiment of the present invention, a method for extending a cord includes locating an internal mating on a female adapter of the cord and locating an external mating on a male adapter of the cord. Further elements to this embodiment are attaching the internal mating to a second external mating of a second cord, attaching the external mating to a second internal mating of the second cord and attaching the external mating to a piece of equipment. The piece of equipment can contain an internal equipment mating structure.

In accordance with yet another embodiment of the present invention, a system for extending a cord includes means for attaching a female adapter of the cord and means for attaching a male adapter of the cord. The means for attaching a female adapter has an internal thread while the means for attaching a male adapter has an external thread. This alternate embodiment can further include means for retracting the means for attaching the female adapter and means for engaging the means for attaching of the female adapter. The means for engaging is a second means for attaching a second male adapter on a second cord.

In accordance with yet another embodiment of the present invention, an apparatus for extending the length of a cord includes a cord comprising a female and a male adapter, a female threaded mating located at the female adapter and a male threaded mating located at the male adapter. The male mating is positioned around an exterior of the male adapter. The female mating is a housing which has a thread to enable the housing to mate with another thread.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of the mating structures at each end of a cord according to a preferred embodiment of the invention.

FIG. 2 is an illustration of the present invention at the point of connection to either a piece of equipment or some other device.

FIG. 3 is an another illustration of the present invention in which multiple cords are used to extend the length of a cord between two plugs.

### DETAILED DESCRIPTION

The invention will now be described with reference to the drawing figures, in which like reference numerals refer to like parts throughout. An embodiment in accordance with the present invention provides a method and apparatus that includes a mating device that is placed around or incorporated into either a female or male adapter. The mating device serves as the mechanism for linking and attaching to another cord, a piece of equipment or a source. By attaching the cord to any of these devices, the cord is able to maintain its connection without the possibility of it becoming detached.

The mating devices can freely rotate around a keyed connector. The mating devices lock to each other by mating internal and external threads with a quarter-turn and a bayonet latch.

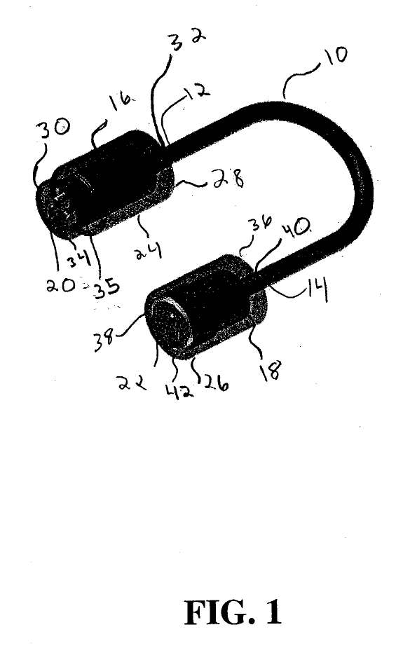

An embodiment of the present inventive apparatus is illustrated in FIG. 1. A line or cord 10 includes a first end 12 and a second end 14. In the preferred embodiment, the first end 12 and second end 14 contain an adapter. A first adapter 16 is located at the first end 12 of the cord 10. A second adapter 18 is located at the second end 14 of the cord 10.

In the preferred embodiment, the first adapter 16 is a male adapter 20. The second adapter 18 is a female adapter 22. In alternate embodiments, the first 16 and second 18 adapters can be reversed or dual female or male adapters can be used.

Placed over the first adapter 16 is a first mating device 24. Placed over the second adapter 18 is a second mating device 26. The first mating device 24 is a tubular structure or housing. At either end of the first mating device 24 is a primary end 28 and a secondary end 30. At the primary end 28, there is an opening 32 for the cord 10 to pass through. The opening 32 is slightly larger than the diameter the of the cord 10. This opening 32 enables the first mating device 24 to be slid over the first adapter 16. Therefore, the first mating device 24 has a larger diameter than the first mating device.

At the secondary end 30 of the first mating device 24, there is an opening 34. The opening 34 is sized to allow the adapter slide in and out of the first mating device 24. In other words, the housing 24 is retractable over the first adapter 16.

In the instance of the male adapter 20, as in the preferred embodiment, external threads 35 protrude forward from the first mating device 24. These threads enable the first mating device 24 to be attached to another mating device. This connection ensures that the cable maintains it connection to a supply or other piece of equipment or cord.

In the preferred embodiment, the second end 14 of the cord 10 contains a second mating device 26. This mating device 26 is placed or positioned over the female adapter 22. The second mating device 26 has a housing that is tubular in shape and has opposing ends 36, 38.

At a first opposing end 36, an opening 40 is made to permit the cord 10 to extend from the female adapter 22. The diameter of the opening 40 is larger than the diameter of the cord 10 in order for the housing to be able to move about the cord 10 and adapter 22.

The second opposing end 38 includes an opening 42 broad enough to pass or locate the second mating device 26 over the female adapter 22. By having the opening 42 larger than the female adapter 22, the second mating device 26 is allowed to move forward over the female adapter 22 or retract away from the female adapter 22. The benefit of the retraction or free flow of the second mating device 26 is that the connection of the cord to another device can securely be made without any hindrance. In other words, the connection of a female to male adapter is made without any interference of the mating devices because its retractability.

The second housing 26 at the second opposing end 38. Within the second opposing end 38 has a series of internal threads 40. The threads 40 mate with the threads of another mating device. For example, the external threads 36 of the first mating device mate or intertwine with the internal threads 40 of the second mating device 26. This mating or intertwining forms a connection between the two devices in order for the two mating devices to maintain a connection. Alternate embodiment of the threads are locks or other type of clothing mechanisms such as latches.

In the preferred embodiment, the first mating device 24 is threaded onto the cord 10. Once it is placed onto the cord 10, an adapter, male or female is placed on one end of cord 10. In alternate embodiments, it is possible for only one end of the cord 10 to incorporate the use of the first mating device 24.

In alternate embodiments, the mating devices 24, 26 can be placed on the cord 10 without the need to remove any male or female adapters. In this instance, the mating devices are assembled onto the cord 10 in two pieces. There is an upper piece that connects with the lower piece to form the tubular structure.

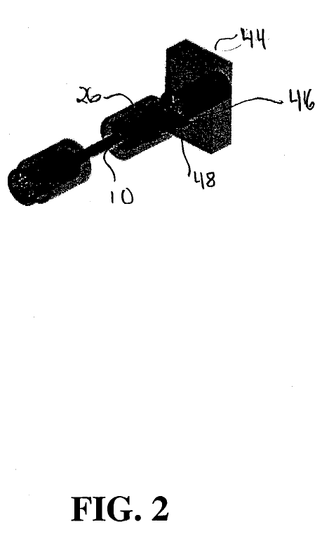

FIG. 2 is an illustration of the present invention at the point of connection to either a piece of equipment or some other device. The first mating device 26 is attached to the receptacle 44. The receptacle 44 includes either a female or male adapter 46 in order to make the connection.

At the area of the adapter 46, the receptacle 44 includes a fastening area 46. The fastening area 48 is either internal or external threads, which are used to seal the cord 10 to the receptacle 44. In the embodiment depicted in FIG. 2, the receptacle 44 contains a male adapter 46. Protruding from the area above the adapter 46 is a series of threads. The first mating device 26 connects to the fastening area 48 by the mating or intertwining of the of the threads.

At the other end of the cord 10 is a second mating device 26, which surrounds the female adapter 22. The female adapter 22 connects to another cord 10 to extend the length of the cord 10 or connect it to a source or a piece of equipment. The second mating device 26 is moved or pushed towards the cord 10 to allow this connection to be made. Once the connection is made, the second mating device 26 is linked to another mating device. At this point, any forces on the cord 10 are absorbed by the first or second mating devices 24, 26 rather than the female and male adapter connection. If these devices were not present, then the cords would become dislodged from the connection point.

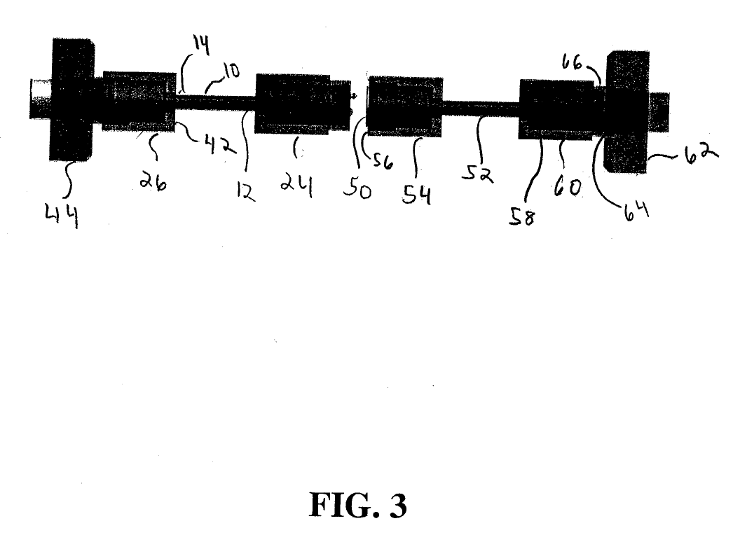

FIG. 3 is an another illustration of the present invention in which multiple cords are used to extend the length of a cord between two plugs. The cord 10 is attached at the second end 14 to the receptacle 44. The receptacle 44 contains the fastening area 48 to which the second mating device 26 is attached. As previously stated, this connection with the receptacle 44 prevents the cord 10 from inadvertently becoming dislodged from the receptacle 44.

At the first end 12 of the cord 10, the male adapter 20 is covered with the first mating device 24. The male adapter 24 is connected to the female adapter 50 of an extension cord 52. This female adapter 50 is covered with a female mating device 54, which connects with the first mating device 24. These two mating device 24, 52 are placed together and twisted to engage the protruding threads and with the female threads 56.

At the other end of the extension cord is a male adapter 58 that is covered with a male mating device 60. The male adapter 58 is connected to a female receptacle 62 to where it obtains power, data, or transmits signals. The receptacle contains a threaded area 64 in order for it to mate with the male mating device 60. The receptacle 62 can be an existing and retrofitted with the threaded area 64 or the receptacle can come preassembled with the threaded area.

The male mating device 60 is twisted such that its protruding threads 66 are linked with the threaded area of the receptacle. The twisting force is applied until the protruding threads 66 are fully located within the receptacle 62.

Once the extension cord is linked and secured to the receptacle 52 and the cord 10, it becomes more difficult for the extension cord 52 to become dislodged from its connection. Therefore, any forces applied to the extension cord are absorbed by the mating devices instead of the connection of the connection of the male and female adapters.

In FIG. 3, the present invention is capable of connecting to receptacle 44 to second mating device 26, which is able to connect to female mating device 54. Additionally, male mating device is able to connect to the receptacle 62. In the present invention, the connection is made with a quarter-turn, bayonet or threaded bodies. The present invention also enables the first mating device 24 to connect or link with female mating device 54 and the receptacle 62 without the need for any additional equipment. Likewise, the female mating device is able to connect with the first mating device 24 and the receptacle 44 without the need for any additional equipment. The universality of the first mating device 24 and the female mating device enable the cords 10, 52 to be connected to each other, receptacles or other pieces of equipment without the need for additional adapters or connectors.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for connecting cords, comprising:
a cord comprising a first end and a second end;
a first adapter attached to the first end of the cord; and
a first mating device configured to be placed over the adapter, the first mating device is configured to be connect to either second cord or a piece of equipment.

2. The apparatus as in claim 1, further comprising a second adapter attached to the second end of the cord.

3. The apparatus as in claim 2, further comprising a second mating configured to be placed over the second adapter, the second mating device is configured to be connect to either the second cord or the piece of equipment.

4. The apparatus as in claim 1, wherein the first adapter is a male adapter.

5. The apparatus as in claim 2, wherein the second adapter is a female adapter.

6. The apparatus as in claim 1, wherein the first mating is retractable.

7. The apparatus as in 3, wherein the second mating is retractable.

8. The apparatus as in claim 6, wherein the first mating is retractable over the first adapter.

9. The apparatus as in claim 1, wherein the first mating is attached to a third mating of a second cord.

10. The apparatus as in claim 7, wherein the second mating is attached to a fourth mating of the second cord.

11. The apparatus as in claim 8, wherein the second cord extends the length cord.

12. The apparatus as in claim 1, wherein the cord is attached to a piece of equipment.

13. The apparatus as in claim 1, wherein the cord is selected from ground of cords consisting of data, power, fluid and telephone.

14. The apparatus as in claim 1, wherein the first mating comprises a housing having a primary and secondary end, the housing is configured to be large enough to be placed around over the first adapter.

15. The apparatus as in claim 14, wherein the primary end comprises a opening for the cord.

16. The apparatus as in claim 14, wherein the secondary end comprises an opening for the first adapter.

17. The apparatus as in claim 16, further comprising external threads extending from the secondary opening.

18. The apparatus as in claim 16, further comprising internal threads located on an interior position approximately near the second opening.

19. A method for extending a cord, comprising:
locating an internal threaded mating on a female adapter of the cord, the internal threaded mating is configured to be attached to another cord or a piece of equipment; and
locating an external threaded mating on a male adapter of the cord, the external threaded mating is configured to be attached to the another cord or the piece of equipment.

20. The method as in claim 19, further comprising attaching the internal mating to a second external mating of a second cord.

21. The method as in claim 20, further comprising attaching the external mating to a second internal mating of the second cord.

22. The method as in claim 19, further comprising attaching the external mating to a piece of equipment.

23. The method as in claim 22, wherein the piece of equipment comprises an internal equipment mating structure.

24. A system for extending a cord, comprising:
means for attaching a female adapter of the cord, the means for attaching the female adapter having an internal thread, the means for attaching the female adapter is configured to be attached to another cord or a piece of equipment; and
means for attaching a male adapter of the cord, the means for attaching the male adapter having an external thread, the means for attaching the female adapter is configured to be attached to another cord or a piece of equipment.

25. The system as in claim 24, further comprising means for retracting the means for attaching the female adapter.

26. The system as in claim 24, further comprising means for engaging the means for attaching of the female adapter.

27. The system as in claim 26, wherein the means for engaging is a second means for attaching a second male adapter on a second cord.

28. The system as in claim 24, further comprising means for connecting means for attaching of the male adapter to a piece of equipment.

29. An apparatus for extending the length of a cord comprising:
a cord comprising a female adapter and a male adapter;
a female threaded mating located at the female adapter, the female threaded mating is configured to be attached to another cord or a piece of equipment with the need of additional parts; and
a male threaded mating located at the male adapter, the male threaded mating is configured to be attached to the another cord or the piece of equipment with the need of additional parts.

30. The apparatus as in claim 28, wherein the male mating is positioned around an exterior of the male adapter.

31. The apparatus as in claim 28, wherein the female mating is a housing comprising a thread to enable the housing to mate with another thread.
